(19) United States
(12) Patent Application Publication
(10) Pub. No.: US 2010/0135253 A1
(43) Pub. Date: Jun. 3, 2010

(54) METHOD OF PROVIDING SESSION MOBILITY AND USER TERMINAL

(75) Inventors: Joo-chul LEE, Daejeon-si (KR); Young-il CHOI, Daejeon-si (KR); Byung-sun LEE, Daejeon-si (KR)

Correspondence Address: LADAS & PARRY LLP, 224 SOUTH MICHIGAN AVENUE, SUITE 1600, CHICAGO, IL, 60604, US

(73) Assignee: ELECTRONICS AND TELECOMMUNICATIONS RESEARCH INSTITUTE, Daejeon-si (KR)

(21) Appl. No.: 12/627,431

(22) Filed: Nov. 30, 2009

(30) Foreign Application Priority Data
Dec. 3, 2008 (KR) 10-2008-0121912

(51) Int. Cl. H04W 36/00

(52) U.S. Cl. 370/331

(57) ABSTRACT

A method of providing session mobility and a user terminal are provided. The method includes, when a session is set through one interface, receiving a request for session transfer to a network corresponding to another interface, checking the available resource capacity of the network to which the session will be transferred, and determining whether or not to transfer the session based on the result of the check operation and establishing a session with the network. The method can improve the reliability of an Internet protocol (IP) multimedia subsystem (IMS) service continuity function.

### CROSS-REFERENCE TO RELATED APPLICATION

This application claims the benefit under 35 U.S.C. §119(a) of Korean Patent Application No. 10-2008-0121912, filed on Dec. 3, 2008, the disclosure of which is incorporated herein in its entirety by reference.

### BACKGROUND

1. Field

The following description relates to an Internet protocol (IP) multimedia subsystem (IMS), and more particularly, to a method of providing session mobility and a user terminal.

2. Description of the Related Art

An IMS of the third generation partnership project (3GPP) is a framework satisfying requirements for providing a session initiation protocol (SIP)-based session control base to a service provider's network. Basically, the 3GPP IMS has been developed to protect a session-based service of a service provider. The IMS interoperates with a network transport layer to efficiently provide an IP multimedia service, and facilitates development of various application services. In particular, a third party service provider other than a communication network provider is also enabled to develop service interoperating with the IMS using an open-access architecture.

Also, an IMS service platform has been designed to control a session established between peers. The IMS only performs signaling and control of a session and has nothing to do with actual data transmission. In the IMS, an Internet engineering task force (IETF)-standardized SIP is used as a call processing protocol between peers.

Since the IMS was introduced in 3GPP Release 5, a voice call continuity service was developed by Release 7. Since Release 8, an IMS service continuity function was added in order to support a continuity service for various multimedia data as well as a voice service. The IMS service continuity function is mainly under the charge of a multimedia session continuity application server (MMSC AS).

Also, media independent handover (MIH) of the institute of electrical and electronics engineers (IEEE) 802.21 has been suggested to aid in handover of a user terminal moving through various types of access networks. Here, the various access networks may denote IEEE 802.x networks. MIH provides information relating to handover in the link layer to an upper layer, and the information is used for handover optimization.

### SUMMARY

The following description relates to a method of providing session mobility capable of increasing the reliability of a session continuity service provided in a service network, and a user terminal.

According to an exemplary aspect, there is provided a method of providing session mobility implemented in a user terminal having interfaces corresponding to two or more networks, the method including: when a session is set through one of the interfaces, receiving a request for session transfer to a network corresponding to another interface; checking available resource capacity of the network to which the session will be transferred; and determining whether or not to perform session transfer based on the result of the check operation, and establishing a session with the network.

The checking of the available resource capacity may include requesting information about the available resource capacity of the network to which the session will be established to a handover information providing server and receiving the information about the available resource capacity of the network from the handover information providing server in response to the request.

The handover information providing server may be a media independent handover (MIH) server.

According to another exemplary aspect, there is provided a method of providing session mobility, including: receiving a session transfer request from a user terminal; checking available resource capacity of a network being accessed based on multimedia stream information included in the session transfer request; and determining whether or not to establish a session according to the result of the check operation, and establishing the session.

According to still another exemplary aspect, there is provided a user terminal, including: a communicator including different types of two or more interfaces; a network checker checking, when a session is established through one of the interfaces and a request for session transfer to a network corresponding to another interface is received, available resource capacity of the network corresponding to the other interface; and a session establishment unit establishing a session to the network corresponding to the other interface according to the result of the check operation of the network checker.

The network checker may include an information requester requesting information about the available resource capacity of the network to which the session will be established from a handover information providing server, an information obtainer obtaining the information about the available resource capacity of the network from the handover information providing server in response to the request, and an establishment determiner determining whether or not to establish the session based on the obtained information.

According to another exemplary aspect, there is provided a user terminal, including: a network checker checking, when a session transfer request is received from another user terminal, available resource capacity of a network being accessed based on multimedia stream information included in the session transfer request; and a session establishment unit performing session establishment based on the session transfer request according to the result of the check operation of the network checker.

Additional aspects of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIGS. 1 and 2 illustrate examples of a session continuity service for the same user terminal.

FIG. 3 is a block diagram of a user terminal according to an exemplary embodiment.

FIG. 4 is a block diagram of a media independent handover (MIH) server according to an exemplary embodiment.

FIGS. 5 and 6 are signal flow diagrams illustrating a method of providing session mobility according to an exemplary embodiment.

FIG. 7 illustrates an example of a session continuity service for one of a plurality of user terminals to continually receive service that another user terminal has received.

FIG. 8 is a block diagram of a user terminal according to another exemplary embodiment.

FIGS. 9 and 10 are signal flow diagrams illustrating a method of providing session mobility according to another exemplary embodiment.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

The Internet is used not only to exchange information but also to purchase products, receive a streaming service, exchange voice data, and so on. Here, at least one session is established between a server that provides service and a user terminal that receives the service. In order to activate a multimedia session and provide continuity, the mobility of the session for multimedia transmission must be provided.

A session is transferred when one user terminal of a user needs to maintain the same service through a different access network, or when one of a plurality of user terminals that a user has needs to continually receive service that another user terminal has received.

First, session mobility provision performed when one user terminal transfers a session to maintain the same service through a different access network will be described in detail with reference to FIGS. 1 to 6.

In an Internet protocol (IP) multimedia subsystem (IMS) to which an exemplary embodiment is applied, multimedia session continuity user terminal (MMSC UE) activates a multimedia session and provides multimedia session mobility between different domains or access systems. Also, it is possible to add, transmit, or reduce transmission medium elements of a communication session between different user terminals capable of processing session transfer.

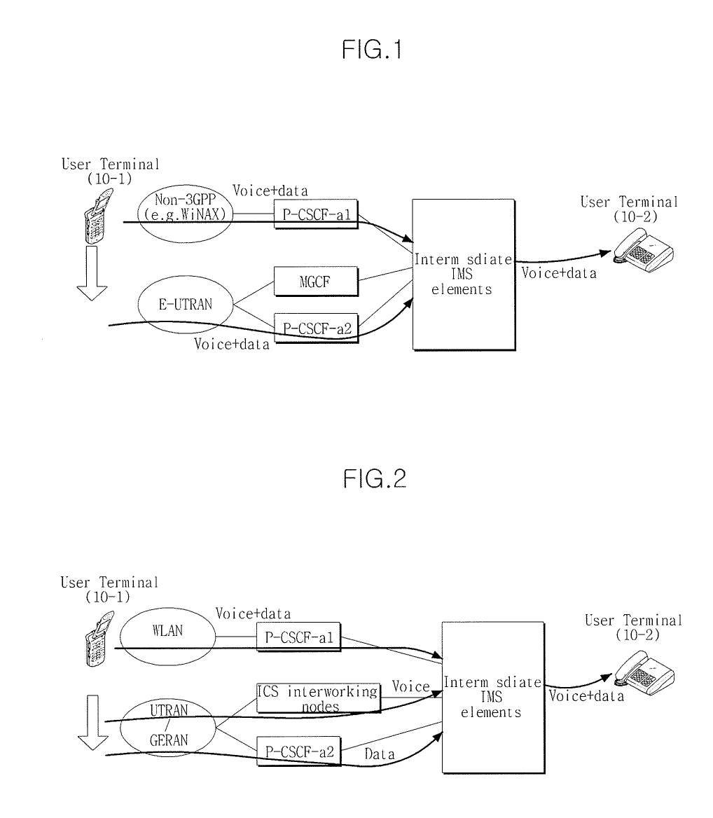

FIGS. 1 and 2 illustrate examples of a session continuity service for the same user terminal.

To be specific, FIG. 1 is an example diagram illustrating session continuity when session mobility is provided to different packet switched (PS) networks. In other words, it shows multimedia session transfer performed when a variety of transmission media are transmitted between different access networks supporting PS communication. Here, session transfer is performed when a user terminal moves from one source PS access network to another target PS access network. Session transfer is performed to provide a user with high-quality service, and during the operation, a seamless state in which access to the target PS access network is enabled is maintained.

In an exemplary embodiment, a user terminal 10-1 performs voice and data communication with another user terminal 10-2 via a non-third generation partnership project (3GPP) IP access network such as worldwide interoperability for microwave access (WiMAX). After this, the user terminal 10-1 moves to another region providing a better communication environment based on wireless signal intensity or another evaluation criterion through an evolved universal terrestrial radio access network (E-UTRAN). Then, a set session and transmission media transmitted through the session are transferred to the E-UTRAN within the limits of the possibility. As illustrated in FIG. 1, this is performed by changing a proxy-call session control function (P-CSCF). More specifically, the configuration of a multimedia session passing through P-CSCF-a1 of the non-3GPP network may be changed to pass through P-CSCF-a2 of the E-UTRAN.

Here, CSCFs of an IMS network process call signals. Also, the CSCFs process subscriber registration, authentication, billing, service-specific triggering, routing to the corresponding application, receiver location inquiry, and compression and decompression of session initiation protocol (SIP) messages, and perform setting, adjustment and management of sessions of users. CSCFs are infra systems performing a basic function for SIP-based multimedia session control, and may be classified into a P-CSCF, an interrogating-CSCF (I-CSCF), and a serving-CSCF (S-CSCF) according to their functions.

The P-CSCF is a first contact point that a user terminal accesses in an IMS network, and serves as a proxy between the user terminal and an S-CSCF when an SIP call is established. The I-CSCF is a first contact point in one service provider network, and searches for an S-CSCF in which a terminating user terminal is registered or an originating S-CSCF of a user roaming in the service area of a current service provider network.

The S-CSCF registers that it is a server controlling a session of a user terminal in a home subscriber server (HSS), and obtains and stores subscriber information of the user terminal. Also, the S-CSCF performs session control and state management for the registered user terminal. Furthermore, the S-CSCF interoperates with another application server to provide various services, or forwards SIP request and reply messages to a breakout gateway control function (BGCF) to route a message transmitted through a public switched telephone network (PSTN). In this exemplary embodiment, the S-CSCF finds out information about a user terminal based on a received SIP message, and transmits SIP messages including a call connection request received from an originating user terminal to a terminating user terminal via a P-CSCF in a network.

FIG. 2 is an example diagram illustrating session continuity when session transfer is performed between a network in which a PS network and a circuit switched (CS) network are mixed and an access network supporting only PS communication. Session transfer is needed when a user moves from one source access network to another target access network. Typically, one access network supports a real-time transmission medium such as voice provided by a CS domain such as global system for mobile communications (GSM)/enhanced data rates for GSM evolution (EDGE) radio access network (GERAN) or UTRAN, and the other access network can support both of real-time transmission medium communication and non-real-time transmission medium communication through a PS bearer such as an E-UTRAN, WiMAX, and wide local area network (WLAN).

To provide a user with high quality service, a session must be transferred to the target access network in the seamless state as long as possible.

In an exemplary embodiment, a user terminal 10-1 may establish a session for voice and data communication to a user terminal 10-2 through a non-3GPP access network supporting IMS multimedia telephone communication. After this, the user terminal 10-1 moves to an access network, such as GERAN or UTRAN, supporting only voice communication through a CS bearer. Transmission media are separated into voice transmitted through the CS domain and data transmitted through an IMS/operating system (OS) domain such that a multimedia session can be transferred to an access network such as GERAN or UTRAN and maintained.

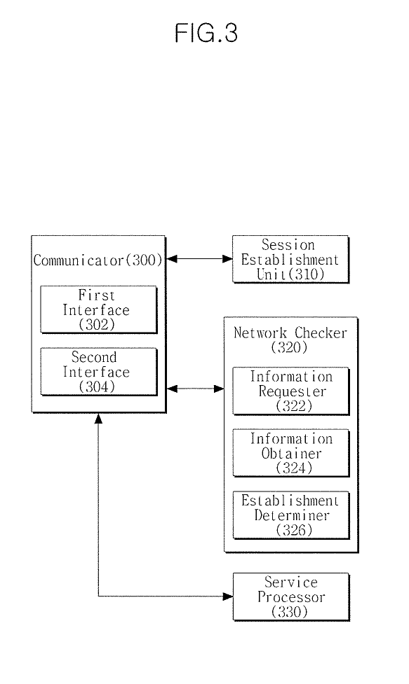

FIG. 3 is a block diagram of a user terminal according to an exemplary embodiment.

As shown in the drawing, the user terminal according to an exemplary embodiment includes a communicator 300, a session establishment unit 310, a network checker 320, and a service processor 330.

The communicator 300 has two or more interfaces. In this exemplary embodiment, a first interface 302 may perform communication via non-3GPP network such as WiMAX, and a second interface 304 may perform communication via a network such as E-UTRAN. However, exemplary embodiments are not limited to these examples.

The session establishment unit 310 establishes a session for multimedia data transmission. In an exemplary embodiment, the session establishment unit 310 may transmit a SIP INVITE message to another user terminal to which a session will be established, thereby requesting SIP session establishment. And, the session establishment unit 310 may receive a response to the request and establish the session. Also, the session establishment unit 310 may perform establishment for multimedia transmission by transmitting an access request to a service server through the communicator 300.

However, according to a characteristic of exemplary embodiments, the session establishment unit 310 establishes a session based on a network check result provided by the network checker 320, which will be described below, before attempting session establishment.

When a session is established through the first interface 302 or the second interface 304 of the communicator 300, the network checker 320 may receive a request for session establishment via another interface. In this case, the network checker 320 checks the available resource capacity of a network corresponding to the other interface.

For example, when the user terminal moves, the request for session establishment via another interface may be received. Otherwise, the request for session establishment via another interface may be directly input by a user.

The network checker 320 includes an information requester 322, an information obtainer 324, and an establishment determiner 326.

The information requester 322 requests information about the available resource capacity of another network to which a session will be established from a handover information providing server. In this exemplary embodiment, the handover information providing server may be a media independent handover (MIH) server.

Here, the MIH server has been developed to aid in handover of a user terminal moving between various types of access networks.

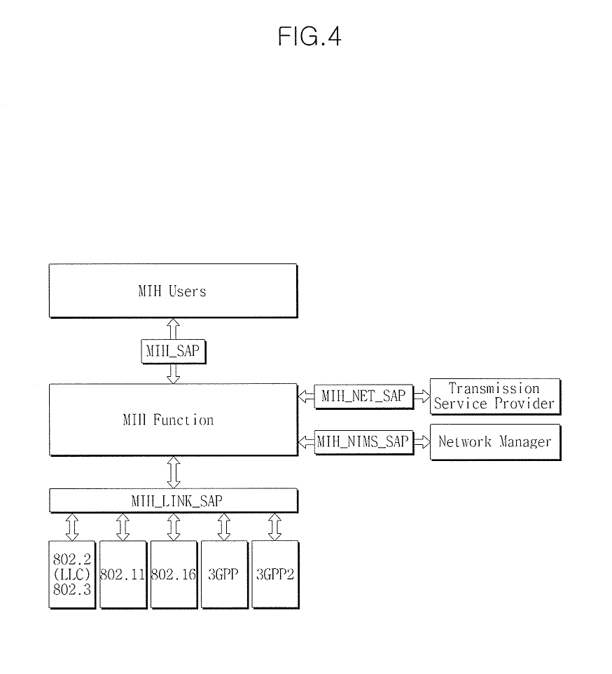

FIG. 4 is a block diagram of a MIH server according to an exemplary embodiment.

MIH users are entities such as user terminals receiving service provided by a MIH function (MIHF), and can communicate with the MIHF using a MIH_service access point (SAP). Also, the MIH server, that is, the MIHF accesses various communication networks via a MIH_LINK_SAP, and has a protocol stack for the communication networks.

The MIH server provides information about handover in the link layer to an upper layer, and the information may be used for handover optimization in a system. More specifically, the MIH server provides three types of services, that is, a media independent event service (MIES) of transferring handover trigger information of the link layer to an upper layer, a media independent command service (MICS) of controlling a handover-related operation of the link layer, and a media independent information service (MIIS) of providing information about a target network for correct handover determination. In particular, the information request 322 may request information from the MIIS of the MIH server. The MIIS searches for and collects handover-related information. At this time, the MIIS may receive information of neighboring networks as an event. In an exemplary embodiment, the information requester 322 transfers a MIH_Get_Information request message, thereby requesting information about the available resource capacity of a network to which a session will be established.

The information obtainer 324 obtains the information about the available resource capacity of the network to which a session will be established from the handover information providing server according to the available resource capacity information request of the information requester 322. In this exemplary embodiment, the information obtainer 324 may obtain the information about the available resource capacity of the network to which a session will be established by receiving a MIH_Get_Information response message from the MIIS of the MIH server.

Here, the information about available resource capacity may be based on at least one of quality of service (QoS), a result of a signal intensity measurement operation, a state of network resources, the amount of data transmission, and a service provider's policy. However, the information about available resource capacity may be based not only on these examples but also on a network spec value whereby it can be determined whether or not a multimedia service can be continually provided even if the multimedia service that has been previously provided to a user terminal is transferred to a new session established in a network, that is, any values whereby available resource capacity can be determined.

The establishment determiner 326 determines whether or not to establish a session based on the information about the available resource capacity of the network to which the session will be established obtained by the information obtainer 324. When the establishment determiner 326 determines that session transfer is appropriate, the session establishment unit 310 establishes a session in the new network, as mentioned above. In this exemplary embodiment, the establishment determiner 326 may determine whether or not to establish a session by comparing spec information of the network to which the session will be established obtained by the information obtainer 324 with a predetermined reference value. For example, when QoS is a predetermined value or less, or reception signal intensity is a predetermined value or less, the establishment determiner 326 may determine that session establishment is impossible. However, exemplary embodiments are not limited to these examples and may include various modifications.

The service processor 330 processes service provided through the session set by the session establishment unit 310, and may be implemented by a microprocessor, etc., included in the user terminal. In this exemplary embodiment, the service processor 330 includes a technical architecture capable of performing a variety of service functions provided through a session, such as voice call processing, image data reproduction, and music data reproduction.

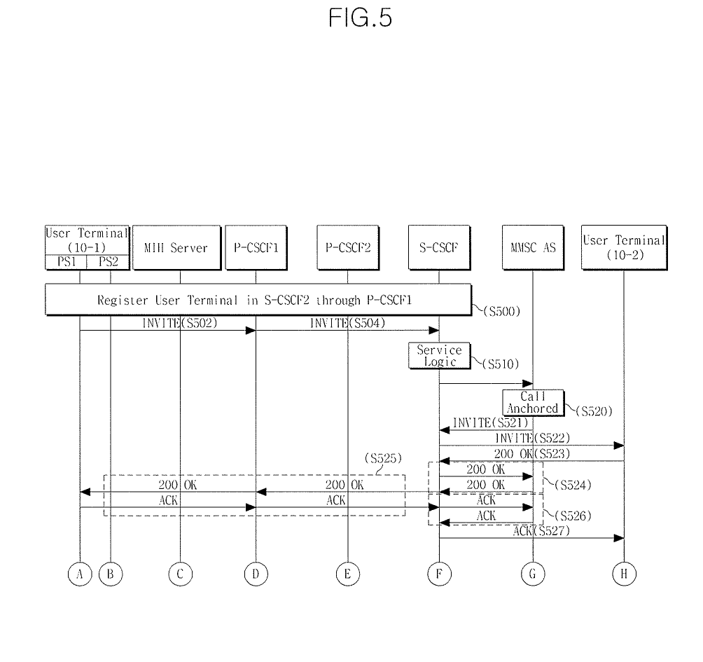

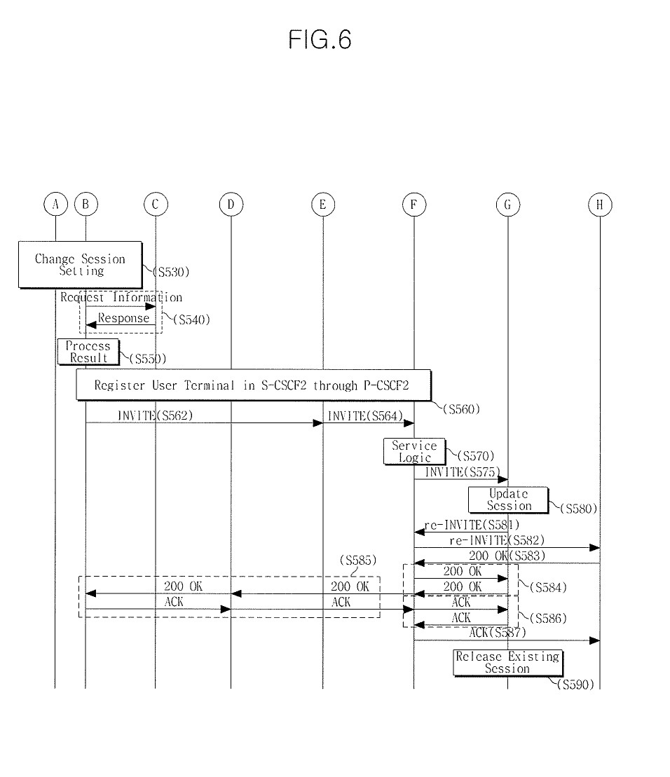

FIGS. 5 and 6 are signal flow diagrams illustrating a method of providing session mobility according to an exemplary embodiment.

Here, a user terminal 10-1 includes two or more interfaces PS1 and PS2 to access various access networks. The user terminal 10-1 may be registered in S-CSCF through the interface PS1 and P-CSCF1 (S500). A multimedia session continuity (MMSC) user initializes a multimedia session in a PS1 system (S502). P-CSCF1 transfers an INVITE message for the user terminal 10-1 to S-CSCF (S504). Then, S-CSCF finds a service logic required according to the received INVITE message (S510). As mentioned above, an S-CSCF interoperates with another application server to provide various services, and performs operation required for providing the services. Here, when a session transfer request is received, S-CSCF forwards the INVITE message to a multimedia session continuity application server (MMSC AS) through an IMS service control (ISC) interface (S515). The MMSC AS continuously manages transfer of multimedia sessions depending on an operator policy. In other words, multimedia sessions are anchored at the MMSC AS (S520).

The MMSC AS forwards the INVITE message via S-CSCF (S521) to another user terminal 10-2 (S522). Subsequently, the user terminal 10-2 transmits a 200 OK response message to the user terminal 10-1 in response to the INVITE message and receives a response to the 200 OK response message such that an initial session can be established between the user terminals 10-1 and 10-2 (S523, 5524, 5525, 5526 and S527).

After this, when the user terminal 10-1 tries to access another access network or obtain a new address for signaling and an access medium (S530), it requests the available resource capacity information of the other access network to which a session will be newly established from a handover information providing server and obtains the information (S540). In this exemplary embodiment, the handover information providing server may be a MIH server. The user terminal 10-1 transmits a MIH_Get_Information request message to the handover information providing server, thereby requesting the available resource capacity information of the other access network. And, the user terminal 10-1 obtains the available resource capacity information of the other access network from a MIH_Get_Information response message received from the handover information providing server. Subsequently, the user terminal 10-1 capable of accessing two or more access networks determines whether or not to establish a session based on the available resource capacity information of the other access network obtained from the handover information providing server (S550).

At this time, when it is determined that the available resource capacity of the network to which a session will be newly established is not sufficient to provide service after the session is established, the session establishment operation is terminated.

On the other hand, when it is determined that the available resource capacity information of the network to which a session will be newly established is sufficient to provide service, the user terminal 10-1 is registered in the S-CSCF through the other interface PS2, through which a session will be newly established, and P-CSCF2 (S560). Then, the user terminal 10-1 transmits an INVITE message from a PS2 system to P-CSCF2 (S562). Here, the INVITE message transmitted to P-CSCF2 includes multimedia session transfer (MST) information informing the MMSC AS that the INVITE message is for session continuity. P-CSCF2 forwards the INVITE message including the MST information to S-CSCF (S564). Subsequently, S-CSCF finds out a service logic required according to the received INVITE message (S570), and forwards the INVITE message including the MST information to the MMSC AS (S575). Afterwards, the MMSC AS updates a multimedia session based on the MST information (S580), and transmits a re-INVITE message for session update to the user terminal 10-2 (S581 and S582).

After this, the user terminal 10-2 transmits a 200 OK response message to the user terminal 10-1 in response to the re-INVITE message and receives a response to the 200 OK response message such that the session can be re-established between the user terminals 10-1 and 10-2 (S583, 5584, 5585, 5586 and S587).

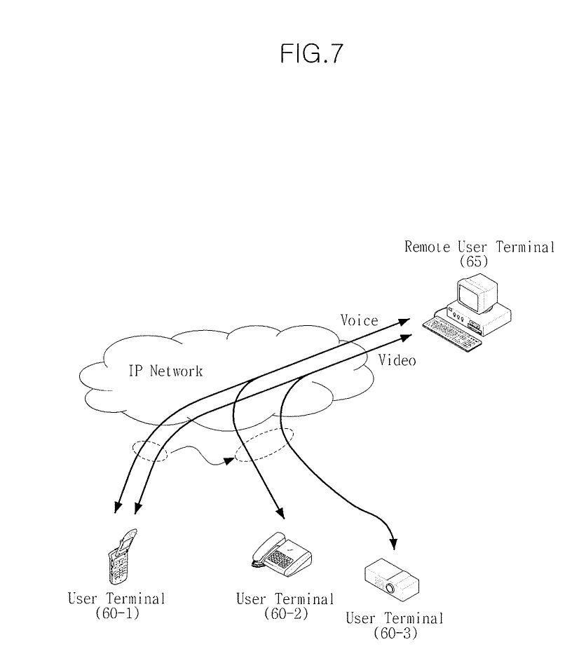

Session mobility provision performed when a session is transferred such that one of a plurality of user terminals continually receives service that another user terminal has received will be described in detail below with reference to FIGS. 7 to 10.

FIG. 7 illustrates an example of a session continuity service for one of a plurality of user terminals to continually receive service that another user terminal has received.

An IMS user may establish a multimedia session between different user terminals that he/she has, and transfer one or more transmission medium components.

For example, the user may establish a multimedia session for audio and video data transmission between a remote user terminal 65 and a user terminal 60-1. After this, the user may transfer an audio component transmission from the user terminal 60-1 to another user terminal 60-2 and a video component transmission to still another user terminal 60-3. In other words, a session for audio transmission may be established between the user terminal 60-2 and the remote user terminal 65, and a session for video transmission may be established between the user terminal 60-3 and the remote user terminal 65. Here, the remote user terminal 65 may be one of the user terminals.

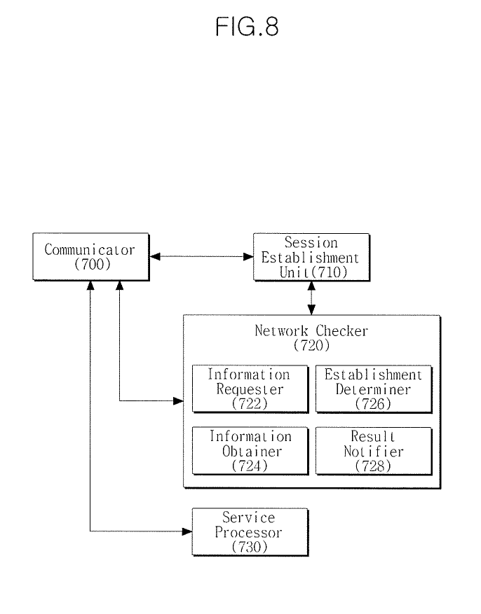

FIG. 8 is a block diagram of a user terminal according to another exemplary embodiment.

As shown in the drawing, the user terminal according to this exemplary embodiment includes a communicator 700, a session establishment unit 710, a network checker 720, and a service processor 730.

The communicator 700 may perform short-range communication with another user terminal. However, exemplary embodiments are not limited to this example and any network communication may be performed via various access networks. For example, the communicator 700 may perform communication via a non-3GPP network, such as an IP network and WiMAX, and a network such as E-UTRAN, but is not limited to these examples.

The session establishment unit 710 establishes a session for multimedia data transmission. In an exemplary embodiment, the session establishment unit 710 may transmit a SIP INVITE message to another user terminal to which a session will be established, thereby requesting SIP session establishment. And, the session establishment unit 710 may receive a response to the request and establish the session. Also, the session establishment unit 710 may perform establishment for multimedia transmission by transmitting an access request to a service server through the communicator 700.

However, according to a characteristic of exemplary embodiments, the session establishment unit 710 establishes a session based on a network check result provided by the network checker 720, which will be described below, before attempting session establishment.

When a session establishment request for session continuity is received from another user terminal, the network checker 720 checks the available resource capacity of a network corresponding to another interface. The network checker 720 includes an information requester 722, an information obtainer 724, an establishment determiner 726, and a result notifier 728.

The information requester 722 requests information about the available resource capacity of a network being accessed from a handover information providing server. In this exemplary embodiment, the handover information providing server may be a MIH server. In an exemplary embodiment, the information requester 722 transmits a MIH_Get_Information request message, thereby requesting information about the available resource capacity of the network to which a session will be established.

The information obtainer 724 obtains the information about the available resource capacity of the network being accessed from the handover information providing server according to the available resource capacity information request of the information requester 722. In this exemplary embodiment, the information obtainer 724 may obtain the information about the available resource capacity of the network to which a session will be established by receiving a MIH_Get_ Information response message from the MIIS of the MIH server.

Here, the information about available resource capacity may be based on at least one of QoS, a result of a signal intensity measurement operation, a state of network resources, the amount of data transmission, and a service provider's policy. However, the information about available resource capacity is based not only on these examples but also on a network spec value whereby it can be determined whether or not a multimedia service can be continually provided even if the multimedia service that has been previously provided to a user terminal is transferred to a new session established in a network, that is, any values whereby available resource capacity can be determined.

The establishment determiner 726 determines whether or not to establish a session based on the information about the available resource capacity of the network currently accessed obtained by the information obtainer 724. When the establishment determiner 726 determines that session establishment is proper, the session establishment unit 710 establishes a session, as mentioned above. In this exemplary embodiment, the establishment determiner 726 may determine whether or not to establish a session by comparing spec information of the network being accessed obtained by the information obtainer 724 with a predetermined reference value. For example, when QoS is a predetermined value or less, or reception signal intensity is a predetermined value or less, the establishment determiner 726 may determine that session establishment is impossible. However, exemplary embodiments are not limited to these examples and may include various modifications.

The result notifier 728 transmits the determination result of the establishment determiner 726 to the other user terminal transmitting the session transfer request.

The service processor 730 processes service provided through the session set by the session establishment unit 710, and may be implemented by a microprocessor, etc., included in the user terminal. In this exemplary embodiment, the service processor 730 includes a technical architecture capable of performing a variety of service functions provided through a session, such as voice call processing, image data reproduction, and music data reproduction.

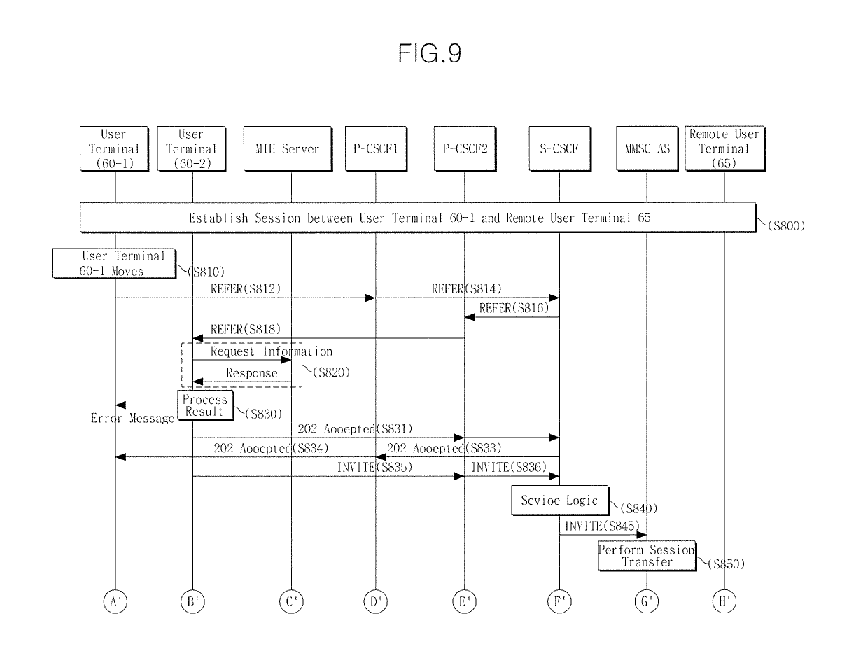

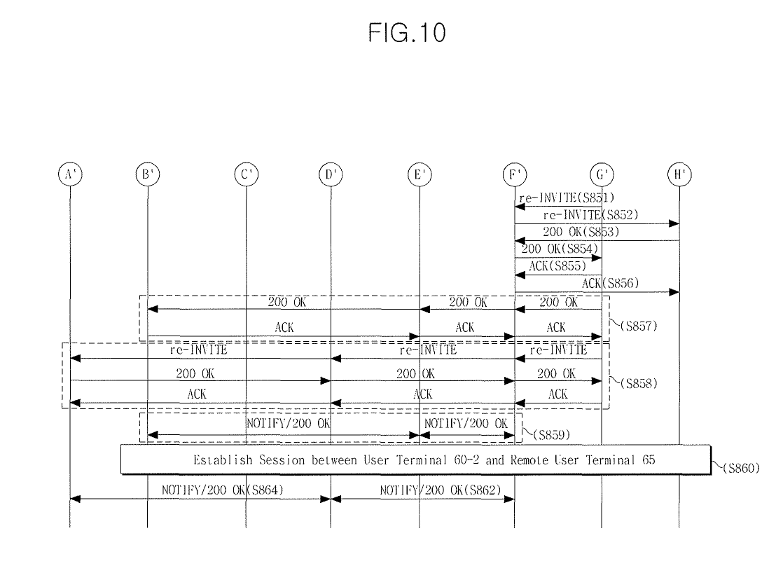

FIGS. 9 and 10 are signal flow diagrams illustrating a method of providing session mobility according to another exemplary embodiment.

Here, a user terminal 60-1 may establish a multimedia session with a remote user terminal 65 via a MMSC AS (S800). Under the control of a MMSC user, the user terminal 60-1 performs session transfer for transmitting one transmission medium to another user terminal 60-2 (S810). Subsequently, in order to transfer the specific session from the user terminal 60-1 to the other user terminal 60-2, the user terminal 60-1 transmits a REFER message including MST information for informing that the REFER message is for multimedia session continuity to the other user terminal 60-2 (S812, 5814, 5816 and S818).

Then, the user terminal 60-2 receiving a session transfer request requests information about the available resource capacity information of a network being accessed from a handover is information providing server, and obtains the information in response to the request (S820).

Subsequently, the user terminal 60-2 receiving the session transfer request determines whether or not to establish a session based on the available resource capacity information of the network being accessed obtained from the handover information providing server, and transmits the result of the determination operation to the user terminal 60-1 that is currently in the multimedia session (S830). Here, when it is determined that the resources of the network being accessed are not appropriate for establishing a session, the user terminal 60-2 receiving the session transfer request transmits an error message to the user terminal 60-1 transmitting the session transfer request.

On the other hand, when it is determined that the available resource capacity of the network being, accessed is appropriate for establishing a session, the user terminal 60-2 receiving the session transfer request transmits an ACCEPTED message indicating that session transfer is permitted via P-CSCF2 to which the user terminal 60-2 itself belongs (S831) to the user terminal 60-1 transmitting the session transfer request (S832, 5833 and S834).

After this, the user terminal 60-2 receiving the session transfer request transmits an INVITE message to P-CSCF2 (S835). Here, the INVITE message transmitted to P-CSCF2 includes MST information informing the MMSC AS that the INVITE message is for session continuity.

P-CSCF forwards the INVITE message including the MST information to S-CSCF (S836). Subsequently, S-CSCF finds a service logic required according to the received INVITE message (S840), and forwards the INVITE message including the MST information to the MMSC AS (S845).

Afterwards, the MMSC AS associates a new access leg with a remote leg of the multimedia session established between the MMSC AS and the remote user terminal 65 (S850).

And, the MMSC AS transmits a re-INVITE message for session update to the remote user terminal 65 via S-CSCF (S851 and S852). Subsequently, the remote user terminal 65 transmits a 200 OK response message to the MMSC AS in response to the re-INVITE message, and the MMSC AS transmits a response to the 200 OK response message to the remote user terminal 65 (S853, S854, 5855 and S856).

After this, the MMSC AS receives a session continuity message from the remote user terminal 65 by transmitting a 200 OK message to the user terminal 60-2, and the user terminal 60-2 transmits an ACK message to the MMSC AS in response to the 200 OK message (S857). Subsequently, the MMSC AS transmits a re-INVITE message to the user terminal 60-1 transmitting the session transfer request, thereby removing transmission of the transmission medium transmitted through the previously set session (S858).

The user terminal 60-2 receiving the session transfer request transmits a NOTIFY message to P-CSCF2, and a session is established between the user terminal 60-2 and the remote user terminal 65 (S860). Subsequently, the user terminal 60-1 transmitting the session transfer request is informed of session transfer (S862 and S864).

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

As apparent from the above description, the available capacity of a network is checked in advance, and a multimedia session transfer operation is processed in consideration of the is available capacity. Thus, the reliability of an IMS service continuity function can be increased.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A method of providing session mobility implemented in a user terminal having interfaces corresponding to two or more networks, the method comprising:
when a session is set through one of the interfaces, receiving a request for session transfer to a network corresponding to another interface;
checking available resource capacity of the network to which the session will be transferred; and
determining whether or not to perform session transfer based on the result of the check operation, and establishing a session with the network.

2. The method of claim 1, wherein the checking of the available resource capacity includes:
requesting information about the available resource capacity of the network to which the session will be established to a handover information providing server; and
receiving the information about the available resource capacity of the network from the handover information providing server in response to the request.

3. The method of claim 2, wherein the handover information providing server is a media independent handover (MIH) server.

4. The method of claim 1, wherein the establishing of the session includes terminating the session transfer when it is determined that session establishment is not permitted.

5. The method of claim 4, further comprising, after the checking of the available resource capacity, outputting an error message when the session transfer is not permitted.

6. The method of claim 1, wherein the available resource capacity is information based on at least one of quality of service (QoS), a result of a signal intensity measurement operation, a state of network resources, an amount of data transmission, and a service provider's policy.

7. A method of providing session mobility, comprising:
receiving a session transfer request from a user terminal;
checking available resource capacity of a network being accessed based on multimedia stream information included in the session transfer request; and
determining whether or not to establish a session according to the result of the check operation, and establishing the session.

8. The method of claim 7, wherein the session transfer request further includes address information of the user terminal.

9. The method of claim 7, further comprising transmitting the result of the check operation to the user terminal.

10. The method of claim 9, wherein the transmitting of the result includes transmitting an error message to the user terminal when the session establishment is not permitted as the result of the check operation.

11. The method of claim 7, wherein the checking of the available resource capacity includes:
requesting information about the available resource capacity of the network to a handover information providing server; and
receiving the information about the available resource capacity of the network from the handover information providing server in response to the request.

12. The method of claim 11, wherein the handover information providing server is a media independent handover (MIH) server.

13. The method of claim 7, wherein the available resource capacity is information based on at least one of quality of service (QoS), a result of a signal intensity measurement operation, a state of network resources, an amount of data transmission, and a service provider's policy.

14. A user terminal, comprising:
a communicator including different types of two or more interfaces;
a network checker checking, when a session is established through one of the interfaces and a request for session transfer to a network corresponding to another interface is received, available resource capacity of the network corresponding to the other interface; and
a session establishment unit establishing a session to the network corresponding to the other interface according to the result of the check operation of the network checker.

15. The user terminal of claim 14, wherein the network checker includes:
an information requester requesting information about the available resource capacity of the network to which the session will be established from a handover information providing server;
an information obtainer obtaining the information about the available resource capacity of the network from the handover information providing server in response to the request; and
an establishment determiner determining whether or not to establish the session based on the obtained information.

16. The user terminal of claim 15, wherein the handover information providing server is a media independent handover (MIH) server.

17. The user terminal of claim 14, wherein the session establishment unit establishes the session using a session initiation protocol (SIP) message.

18. A user terminal, comprising:
a network checker checking, when a session transfer request is received from another user terminal, available resource capacity of a network being accessed based on multimedia stream information included in the session transfer request; and
a session establishment unit performing session establishment based on the session transfer request according to the result of the check operation of the network checker.

19. The user terminal of claim 18, wherein the network checker includes:
an information requester requesting information about the available resource capacity of the network being accessed from a handover information providing server;
an information obtainer obtaining the information about the available resource capacity of the network from the handover information providing server in response to the request; and
an establishment determiner determining whether or not to establish a session based on the obtained information.

20. The user terminal of claim 19, wherein the network checker further includes a result notifier transmitting the result of the determination operation of the establishment determiner to the other user terminal.
